(19) United States
(12) Patent Application Publication
(10) Pub. No.: US 2013/0226998 A1
(43) Pub. Date: Aug. 29, 2013

(54) PROVIDING MACHINE-TO-MACHINE SERVICE

(71) Applicant: KT CORPORATION, (US)

(72) Inventors: Sung-Phil HEO, Seoul (KR); Su-Jin KANG, Seoul (KR); Woo-Hyun KWON, Daegu (KR); Sang-Eon KIM, Seoul (KR); Yeon-Soo KIM, Gyeonggi-do (KR); Hak-Jin CHONG, Seoul (KR)

(73) Assignee: KT CORPORATION, Gyeonggi-do (KR)

(21) Appl. No.: 13/774,389

(22) Filed: Feb. 22, 2013

(30) Foreign Application Priority Data
Feb. 23, 2012 (KR) 10-2012-0018644

(51) Int. Cl. H04L 29/06

(52) U.S. Cl. CPC H04L 67/42
USPC 709/203

(57) ABSTRACT

The disclosure is related to providing a machine-to-machine (M2M) service. Device identification information on a specific M2M device associated with a requested M2M service may be obtained. Device data corresponding to the device identification information may be obtained. A user interface (UI) template corresponding to the requested M2M service may be determined. An M2M application data may be created by combining the obtained device data and the determined UI template.

### CROSS REFERENCE TO PRIOR APPLICATIONS

The present application claims priority under 35 U.S.C. §119 to Korean Patent Application No. 10-2012-0018644 (filed on Feb. 23, 2012), which is hereby incorporated by reference in its entirety.

The subject matter of this application is related to U.S. patent application Ser. No. ______ filed ______, as Attorney Docket No.: (801.0098), the teachings of which are incorporated herein their entirety by reference.

### BACKGROUND OF THE INVENTION

Machine-to-Machine (M2M) communication is a form of data communication that involves one or more entities (e.g., devices) that do not necessarily require human interaction or intervention in the process of communication. The M2M communication may also be referred to as a machine type communication (MTC) or a machine intelligence communication. The M2M communication may extend human-centered internet infrastructure to a human-to-machine domain and/or a machine-to-machine domain where information can be sensed and transmitted not by human beings but by machines. The M2M communication may be related to a ubiquitous technology.

The M2M communication may enable different types of services that are valuable to an end user. For example, M2M communication services may include smart metering, healthcare monitoring (e.g., patient monitoring), fleet management and tracking, remote security sensing, smart grid, telemetry, weather monitoring, home automation, and similar applications.

M2M architecture may include a variety of elements such as M2M devices (e.g., a sensor, an actuator, etc.), M2M area network, M2M communication network (e.g., a core network), M2M gateway (i.e., a system connecting the M2M area network and the M2M communication network), and/or an M2M application service server. Herein, a plurality of M2M devices may be connected by the M2M area network (e.g., a capillary network). Typically, M2M applications may be configured or developed based on M2M platforms (e.g., an M2M application platform). The M2M platforms may be used to provide a variety of M2M application-services based on the collected device data.

An M2M application service may be provided to an end user through the service logic of an associated M2M application. Such M2M application service may be realized based on M2M device data collected from M2M devices and associated M2M application. The M2M application may be installed in user equipment and provide the collected M2M device data to the end user through a user interface (UI) which may be displayed on the user equipment as a result of performing the M2M application. The M2M application may process the collected M2M device data in response to user's inputs received through an associated UI and provide the processed M2M device data through the associated UI.

Such M2M application and an associated UI thereof are created by an M2M service provider or a M2M device manufacturer. Accordingly, the M2M application and the UI thereof are dependent to the M2M service provider and the M2M device manufacturer. That is, the M2M application and the GUI thereof are dependent to corresponding M2M devices. A user may not freely modify or add a UI template of a certain M2M device in the GUI of the M2M application software.

### SUMMARY OF THE INVENTION

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present invention, UI templates to be used in M2M application services may be registered and managed without being dependent on an M2M service provider and/or an M2M device manufacturer. Accordingly, a user may be enabled to configure a user-preferred UI of an M2M application.

In accordance with an embodiment of the present invention, a method may be provided for providing a machine-to-machine (M2M) service. The method may include obtaining device identification information on a specific M2M device associated with a requested M2M service, obtaining device data corresponding to the device identification information, determining a user interface (UI) template corresponding to the requested M2M service, and creating an M2M application data by combining the obtained device data and the determined UI template.

The device identification information may be obtained from an application data request received from an application service server.

The obtaining device data may include sending a device data request based on the device identification information, to an M2M server, and receiving the device data from the M2M server, in response to the device data request.

The determining may include identifying a device type from the device identification information, and retrieving the UI template corresponding to the identified device type, from a storage unit.

The determining may include obtaining template identification information from an application data request, and retrieving the UI template corresponding to the obtained template identification information, from a storage unit.

When the template identification information includes a plurality of template identifiers, the retrieving may include retrieving a plurality of UI templates corresponding to the plurality of template identifiers.

The creating may include creating a plurality of M2M application data by combining each of the plurality of retrieved UI templates and a corresponding device data, and creating an integral application data by combining the plurality of M2M application data.

The method may further include receiving a registration request including at least one UI template, from at least one of a UI template providing system, a user terminal, and a template developer terminal, determining whether each of the at least one template satisfies a predetermined registration condition, and storing a UI template which satisfies the predetermined registration condition.

Each of the at least one UI template may be configured to include at least one of device identification information, a device type, a device data type, a device data range, a device control type, and graphical user interface (GUI) format information.

The predetermined registration condition may be established in association with at least one of the device data type, the device data range, the device control type, and essential constituent information.

The method may be performed by an application data server coupled to at least one of an M2M server and an application service server through an intranet network.

The method may further include sending the created M2M application data to the application service server for transfer of the created M2M application data to a user terminal.

In accordance with another embodiment of the present invention, a method may be provided for registering a user interface (UI) template for a machine-to-machine (M2M) service. The method may include receiving a registration request including at least one UI template, determining whether each of the at least one UI template satisfies a predetermined registration condition, and storing a UI template which satisfies the predetermined registration condition.

Each of the at least UI template may be configured to include at least one of device identification information, a device data type, a device data range, a device control type, and graphical user interface (GUI) format information.

The predetermined registration condition may be established in association with at least one of the device data type, the device data range, the device control type, and essential constituent information.

The method may be performed by an application data server coupled to at least one of an M2M server and an application service server through an intranet network. The registration request may be received from at least one of a UI template providing system, a user terminal, and a template developer terminal.

In accordance with still another embodiment of the present invention, an apparatus may be provided for providing a machine-to-machine (M2M) service. The apparatus may include a template managing unit, an interworking unit, and an application data generating unit. The template managing unit may be configured to store at least one user interface (UI) template. The interworking unit may be configured to obtain a device data from an M2M server. The application data generating unit may be configured to determine a UI template to accommodate the obtained device data among the at least one stored UI template, and to create an M2M application data by combining the obtained device data and the determined UI template.

The interworking unit may be configured to receive an application data request from an application service server, to send a device data request to the M2M server, to receive a corresponding device data from the M2M server, and to send the created M2M application data to the application service server.

The application data generating unit may be configured to obtain at least one of device identification information, a requested service content, and a template identifier (ID) from the application data request, to determine the UI template based on at least one the obtained device identification information and the obtained template identifier (ID), and to create the M2M application data by combining the received corresponding device data and the determined UI template.

The apparatus may be an application data server coupled to at least one of the M2M server and the application service server through an intranet network.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 illustrates a system for providing a M2M service in accordance with at least one embodiment of the present invention;

FIG. 2 illustrates a request-response message exchange procedure for an M2M service between system elements in accordance with at least one embodiment of the present invention;

FIG. 3 illustrates an application data server in accordance with at least one embodiment of the present invention;

FIG. 4A and FIG. 4B illustrate registering a user interface (UI) template in accordance with at least one embodiment of the present invention;

FIG. 5 illustrates creating a user interface (UI) template in accordance with at least one embodiment of the present invention; and

FIG. 6A and FIG. 6B illustrate providing a machine-to-machine (M2M) service in accordance with at least one embodiment of the present invention.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below, in order to explain the present invention by referring to the figures.

In accordance with at least on embodiment of the present invention, UI templates to be used in an M2M application service may be registered and managed without being dependent on an M2M service provider and/or an M2M device manufacturer. For example, a user may freely register UI templates to be used in his/her M2M application service or modify the registered UI template, according to his/her preference, and therefore a user-preferred UI may be realized on the user terminal. Furthermore, in the case that a new M2M device or a new M2M application service is added, if a corresponding UI template is registered, a user may receive the new M2M application service without installing a new UI application in the user terminal.

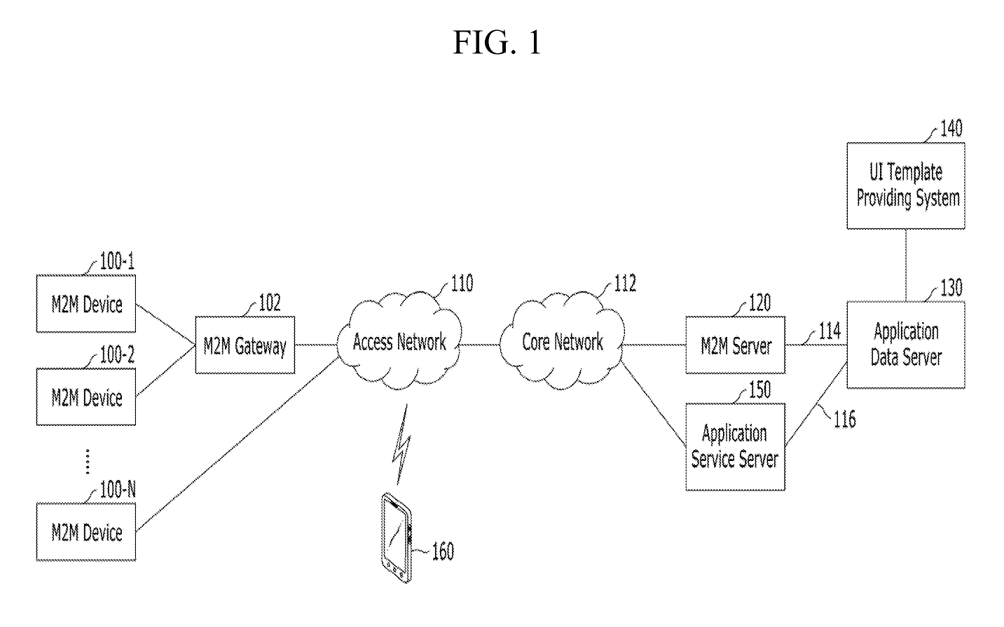

FIG. 1 illustrates a system for providing a M2M service in accordance with at least one embodiment of the present invention.

Referring to FIG. 1, the system for providing an M2M service may include at least one M2M device 100-1 to 100-N, M2M server 120, application data server 130, user interface (UI) template providing system 140, and application service server 150 in accordance with at least one embodiment of the present invention.

M2M devices 100-1 to 100-N to may be installed at a specific location or an object (e.g., a home, a bridge, etc.) and sense and collect related data such as temperature and amount of traffic. M2M devices 100-1 to 100-N may transmit the sensing result or the collected data to a related server. In case of a home-control M2M service, M2M device 100-1 to 100-N may sense or monitor home environment recognize statuses of home electronic appliances, and/or health statuses of family members. For example, M2M devices 100-1 to 100-N may include a temperature control device, a humidity control device, an air conditioning device regulating indoor air quality (IAQ), a heating device, a weighing machine, a motion sensor, an actuator, and so forth.

M2M devices 100-1 to 100-N may send device data (e.g., sensing data) to M2M server 120. M2M devices 100-1 to 100-N may communicate with M2M server 120 through a wired or wireless network. M2M devices 100-1 to 100-N may perform a wired/wireless interface function for communicating with M2M server 120. More specifically, M2M devices 100-1 to 100-N may communicate with M2M server 120 through access network 110 and core network 112. For example, access network 110 may include a wideband code division multiple access (WCDMA) network, a wireless broadband (Wibro) network, a 3^{rd} generation (3G) radio access network, a long-term evolution (LTE) network, and etc. Core network 112 may be the Internet, public switched telephone network (PSTN), and etc. Furthermore, M2M devices 100-1 to 100-N may be directly connected to access network 110 or indirectly connected to access network 110 through M2M gateway 102. M2M gateway 102 may manage M2M area networks of M2M devices 100-1 to 100-N for ensuring M2M devices interworking and interconnected to networks 110 and 112. Core network 112 is the central part of a telecommunication network which provides a variety of services to users or customers who are connected through access network 110. Core network 112 may be the Internet, the PSTN, and so forth. Such M2M devices 100-1 to 100-N may be manufactured by different manufacturers or different M2M service providers in accordance with at least one embodiment of the present invention.

M2M server 120 may be a server operated by an M2M service provider and connected with M2M devices 100-1 to 100-N. More specifically, M2M server 120 may receive and manage device data (e.g., sensing data) from at least one M2M devices 100-1 to 100-N. M2M server 120 may send the received device data to application data server 130. M2M server 120 may communicate with application data server 130 through wired/wireless network 114 such as an intranet network. M2M server 120 may perform a network interface function for communicating with application data server 130.

Furthermore, M2M server 120 may include storage unit 121 in order to store device data which are received from at least one M2M device. Storage unit 121 may include an information storage medium such as a magnetic tape, a hard disk drive (HDD), an optical disk drive (ODD), and/or a solid state drive (SSD).

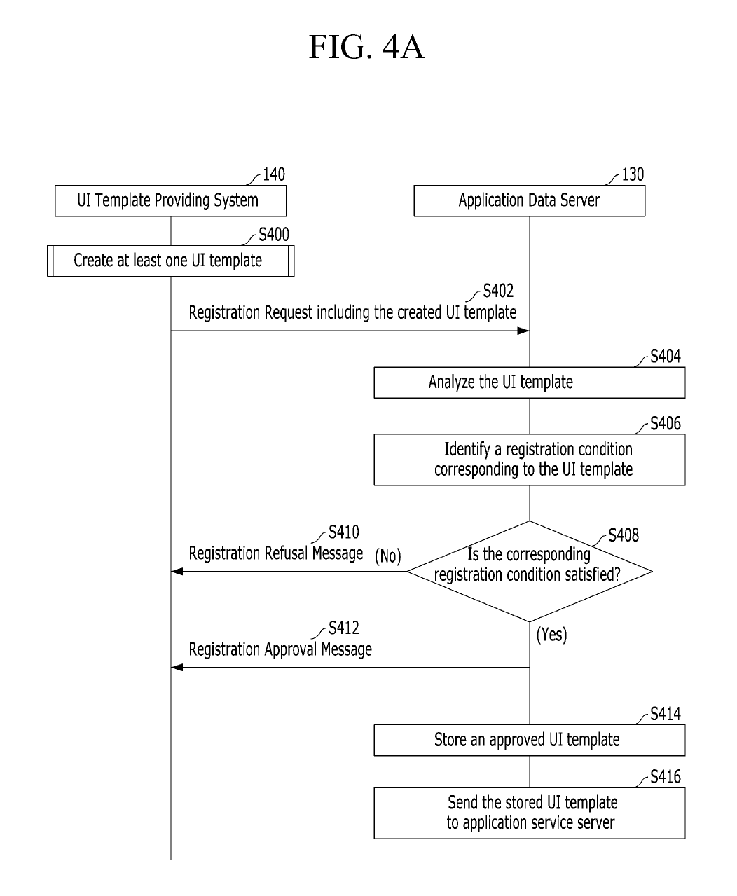

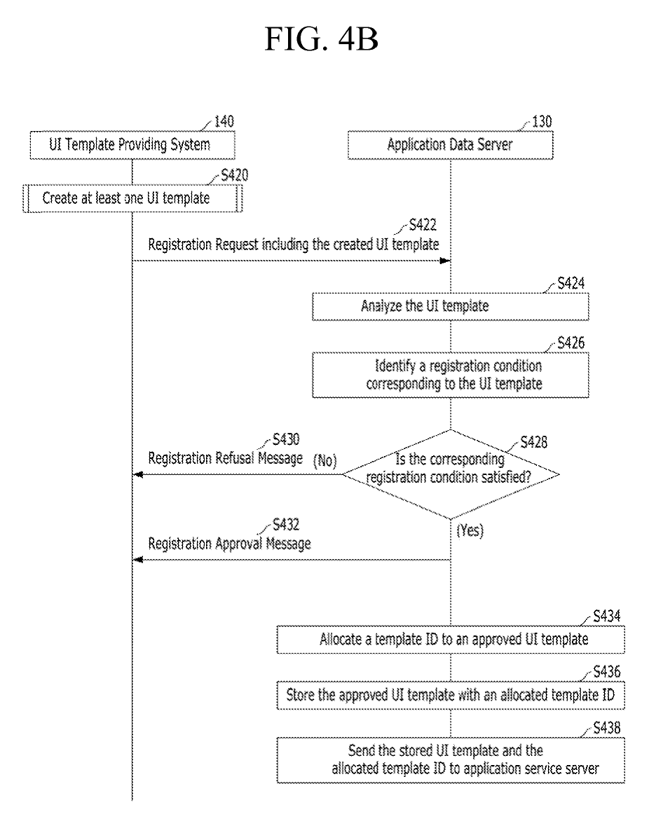

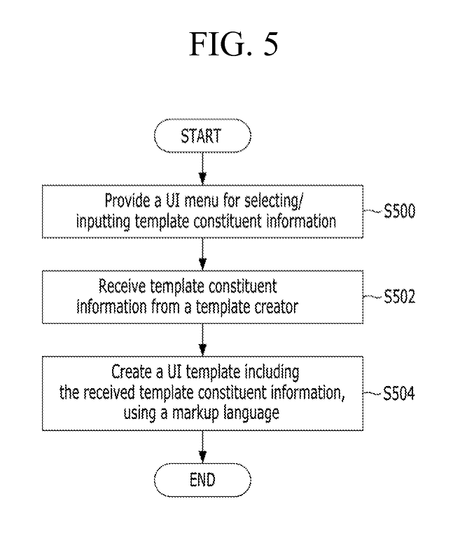

UI template providing system 140 may create a UI template according to a request of a template creator such as a user or a template developer, and send a UI template registration request including the created UI template to application data server 130. The UI template may include at least one of device identification information, a device data type, a device data range, a device control type, and graphical user interface (GUI) format information. The UI template may be differently created or constituted according to M2M device types. Creation and registration procedures of the UI template will be described in more detail with reference to FIG. 4A to FIG. 5. UI template providing system 140 may be managed by an M2M service provider. A user may create a UI template, using a template creation tool provided by UI template providing system 140. In at least one embodiment of the present invention, UI template providing system 140 may be included (or constituted) as a function unit in application data server 130. In this case, user terminal 160 may access application data server 130, and directly send a UI template registration request including a UI template, to application data server 130. In some embodiments of the present invention, UI template providing system 140 may be connected to core network 112. In this case, a user may access UI template providing system 140, and create a UI template to be used in association with his/her application service, through UI template providing system 100. In at least one embodiment for the present invention, application data server 130 may be connected to core network 112. In this case, user terminal 160 may send a UI template registration request including a pre-made UI template to application data server 130 according to a request of a user.

Application data server 130 may perform a registration procedure when receiving a UI template registration request from UI template providing system 140. More specifically, application data server 130 may determine whether a UI template registration request is proper to a corresponding M2M device, i.e., whether the requested UI template satisfies a predetermined registration condition (i.e., UI template registration condition). The predetermined registration condition may indicate minimum requirements (e.g., minimum constituent information, device data type, device data range, etc.) being necessary for a UI template to accommodate device data (i.e., M2M device data). The registration condition may be defined based on characteristics (e.g., types) of M2M devices. Accordingly, the registration condition may be differently determined according to M2M device types. The registration condition may be predetermined by M2M service provider and be inputted in application data server 130.

Furthermore, a UI template may be configured to include at least one of device identification information, a device data type, a device data range, a device control type, and graphical user interface (GUI) format information. Such information may be regarded as essential constituent information for a corresponding UI template. Accordingly, a UI template registration condition may be established in association with at least one of the device data type, the device data range, the device control type, and essential constituent information. For example, when determining whether the requested UI template satisfies a predetermined registration condition, application data server 130 may determine whether minimum constituent information predetermined in association with a corresponding M2M device is included in a corresponding template, and/or whether each constituent information satisfies the template registration condition (e.g., conditions established in association with a device data type, a device data range, and/or a device control type).

More specifically, in the case that M2M device 100-1 is a temperature control device and a predetermined output data type of M2M device 100-1 is “a float type (i.e., a floating point data type),” application data server 130 may determine whether a corresponding UI template is capable of accommodating a float-type device data. Herein, the predetermined device data type corresponds to the predetermined registration condition.

When the requested UI template is proper, i.e., when the requested UI template satisfies the predetermined registration condition, application data server 130 may register and manage a corresponding UI template. That is, application data server 130 may send a registration approval message to UI template providing system 140 and store the approved UI template in storage unit 131. Storage unit 131 may include an information storage medium such as a magnetic tape, a hard disk drive (HDD), an optical disk drive (ODD), and/or a solid state drive (SSD). A registration procedure of the requested UI template will be described in more detail with reference to FIG. 4A and FIG. 4B. When the requested UI template is improper, i.e., when the requested UI template does not satisfy the predetermined registration condition, application data server 130 may send a registration refusal message to UI template providing system 140.

In at least one embodiment of the present invention, application data server 130 may provide a template editing function to a UI template creator (e.g., a user, an M2M provider, a template developer, etc.) who registered at least one UI template. Accordingly, the UI template creator may edit or modify his/her registered UI templates according to his/her preference. In this case, the UI template creator may access application data server 130 “through UI template providing system 140” or “directly” in order to edit or modify his/her registered UI templates.

Meanwhile, when receiving an application data request from application service server 150, application data server 130 may analyze the received application data request and obtain at least one of device identification information and a requested service content from the analysis results. For example, the device identification may be identification information on a specific M2M device associated with an application service request and the requested service content may be a temperature sensing command. In at least one embodiment of the present invention, the received application data request may further include identification information (e.g., template ID) on a predetermined UI template. In this case, application data server 130 may obtain a template ID from the received application data request.

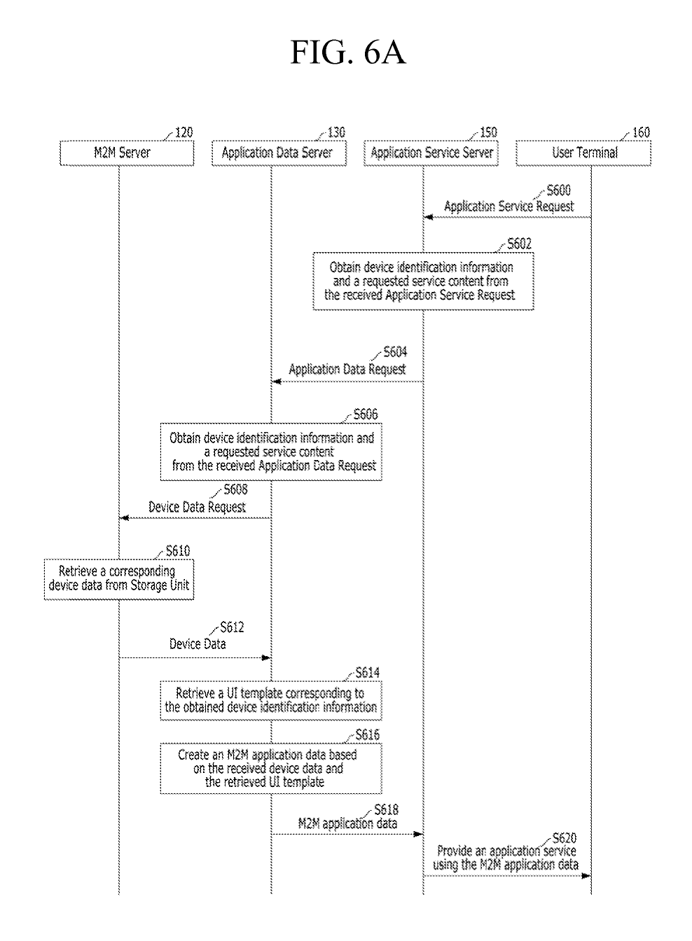

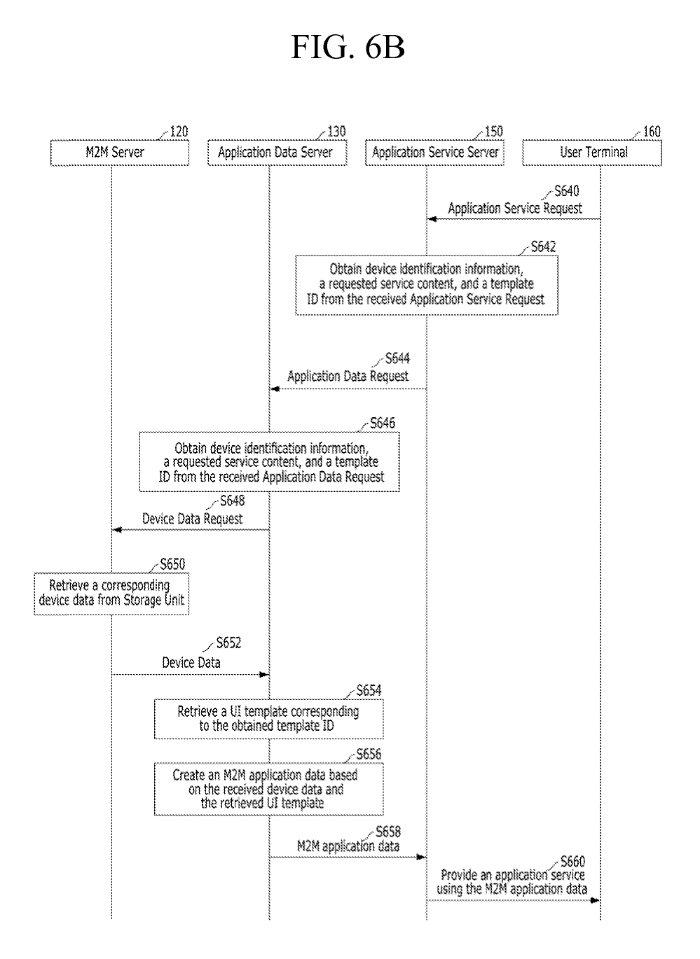

Thereafter, application data server 130 may send a device data request to M2M server 120, on the basis of information (e.g., device identification information) obtained from the received application data request. When receiving a device data in response to the device data request from M2M server 120, application data server 130 may send a corresponding application data to application service server 150 in response to the received application data request. More specifically, application data server 130 may retrieve a UI template corresponding to a specific M2M device associated with the received application data request from storage unit 131 and create a corresponding application data by combining the retrieved UI template with the received device data. For example, the corresponding application data may be created by embedding the received device data in the retrieved UI template. An application data creation procedure will be described in more detail with reference to FIG. 6A to FIG. 7.

As described above, application data server 130 may register/manage UI templates which are received from at least one of UI template providing system 140, user terminal 160, and a template developer terminal. Accordingly, application data server 130 may integrally store/manage UI templates to be applied in association with a variety of M2M application services. Further, application data server 130 may be connected to M2M server 120 and/or application service server 150 through a wired/wireless intranet network 114 and 116. Accordingly, it may be possible to strengthen the security management of UI templates and M2M device data, and perform an efficient management of UI templates.

Application service server 150 may be a server (e.g., a web server) operated by an M2M service provider and operate as a connection point in connection with user terminal 160. Application service server 150 may store and manage subscription information associated with M2M service subscribers (i.e., users). Herein, the subscription information may include user IDs (i.e., subscriber IDs), device identification information of registered M2M devices (i.e., M2M device registered in association with a corresponding M2M application service by M2M service subscribers), subscribed M2M service contents (e.g., an M2M health care service, a smart home service, etc.), template IDs, and so forth. In at least one embodiment of the present, an M2M application service subscriber may select or designate at least one UI template for a corresponding M2M application service. In this case, application service server 150 may store and manage identification information (i.e., template ID(s)) corresponding to the selected/designated UI template. Particularly, when there are a plurality of UI templates for the same M2M device type, application service server 150 may provide user terminal 160 with the plurality of UI templates such that a user may select one of the plurality of UI templates. Further, after selecting at least one UI template for a corresponding M2M application service, a user may change the selected UI templates to other preferred UI templates through application service server 150. That is, application service server 150 may provide a user with a change process of the selected UI templates.

Further, application service server 150 may perform at least one of authentication, authorization, and accounting in association with application service requests of users. In at least one embodiment of the present invention, application service server 150 may perform an AAA procedure (i.e., authentication, authorization, and accounting) interworking with an AAA server (not shown in Figures).

When receiving an application service request from user terminal 160, application service server 150 may analyze the received application service request and send an application data request based on a result of the analysis to application data server 130. Thereafter, when receiving an application data from application data server 130 in response to the application data request, application service server 150 may provide user terminal 160 with an application service based on the received application data. Application service server 150 may transfer the application data received from application data server 130 to user terminal 160. Herein, the transferred application data may correspond to UI data for an application service.

In at least one embodiment of the present invention, application service server 150 may create UI data to be displayed on user terminal 160 by performing a UI process on the transferred application data and send the created UI data to user terminal 160. Herein, the UI process may be a procedure combining a plurality of different application data. For example, the UI process may be a procedure combining “an application data associated with a temperature device” and “an application data associated with a humidity device.” In some embodiment of the present invention, the UI process may be a procedure adding an additional UI component for displaying in user terminal 160.

User terminal 160 may be an electronic device used by a user (i.e., an M2M service subscriber). User terminal 160 may be connected to application service server 150 through wired and/or wireless communication network 110 and 112. For example, user terminal 160 may be, but not limited to, a mobile station (MS), a mobile terminal (MT), a wireless terminal, a smart phone, a cell-phone, a personal digital assistant (PDA), a portable multimedia player (PMP), a wireless communication device, a portable device, a laptop computer, a desktop computer, a tablet personal computer (PC), a digital broadcasting terminal, and so forth. The user may be provided with an M2M service through user terminal 160. More specifically, a user may send a request (i.e., an application service request) for an M2M application service to application service server 150 through user terminal 160. That is, user terminal 160 may send the application service request to application service server 150 in response to user's input that requests a specific application service. When a specific M2M application has been installed in user terminal 160, a user may connect to application service server 150 through the execution of the installed M2M application. When receiving UI data in response to an application service request, user terminal 160 may directly display the received UI data without a specific UI application. For example, a user may register at least one UI template to be used in association with his/her M2M application service, to application data server 130. The user may select at least one of registered UI templates when or after subscribing at least one M2M application service. In this case, user terminal 160 may receive UI data which is created based on the selected UI template, and display the received UI data without a specific UI application.

In at least one embodiment of the present invention, M2M server 120, application data server 130, UI template providing system 140, and application service server 150 may be connected to core network 112. In this case, they may communicate with each other, through core network 112.

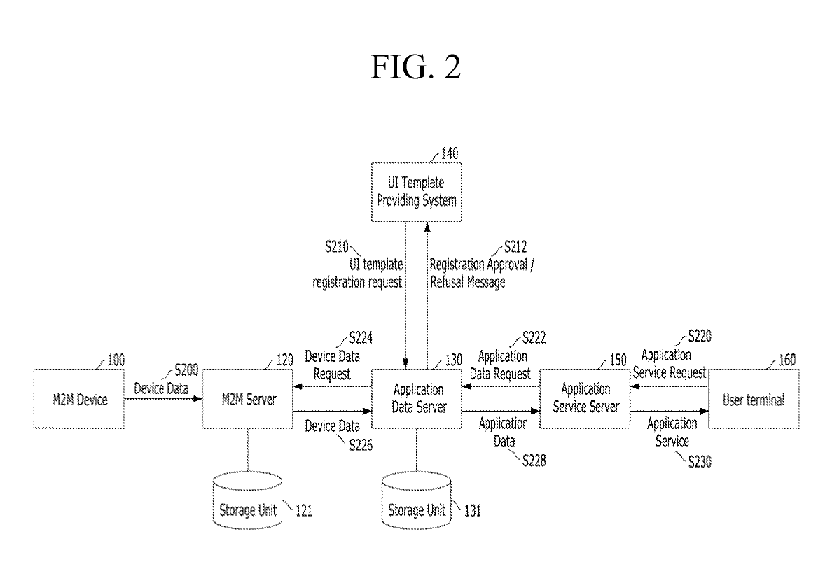

FIG. 2 illustrates a request-response message exchange procedure for an M2M service between system elements (e.g., an M2M device, an M2M server, an application data server, an application service server, etc.) in accordance with at least one embodiment of the present invention. Hereinafter, in the case where one of the at least M2M device 100-1 to 100-N is not particularly specified, the M2M device is referred to as “M2M device 100” for the sake of convenience.

When receiving an application service request (e.g., a request for a room temperature sensing) from user terminal 160 at step S220, application service server 150 may send an application data request to application data server 130 based on the received application service request at step S222. Thereafter, when receiving a corresponding application data from application data server 130 in response to the application data request at step S228, application service server 150 may provide user terminal 160 with an M2M application service based on the received application data at step S230. More specifically, application service server 150 may transfer the received application data to user terminal 160. Herein, the transferred application data may correspond to UI data for an application service. In at least one embodiment of the present invention, application service server 150 may create UI data for an application service by performing a UI process (e.g., combination of different application data associated with the same user, or adding an additional UI component) on the transferred application data, and then send the created UI data to user terminal 160.

With respect to a relationship between application data server 130 and application service server 150, when receiving the application data request from application service server 150 at step S222, application data server 130 may send a device data request based on the received application data request to M2M server 120 at step S224. Further, when receiving the application data request from application service server 150 at step S222, application data server 130 may retrieve a UI template which corresponds to an M2M device (e.g., M2M device 100) associated with the received application data request from storage unit 131. In at least one embodiment of the present invention, the received application data request may further include identification information (e.g., template ID) on a predetermined UI template. In this case, application data server 130 may obtain a template ID from the received application data request and retrieve a UI template corresponding to the obtained temple ID from storage unit 131. An application data creation procedure will be described in more detail with reference to FIG. 6A to FIG. 7.

Thereafter, when receiving corresponding device data (e.g., temperature data) from M2M server 120 at step S226, application data server 130 may create the application data by combining the retrieved UI template and the received device data and send the created application data to application service server 150 in response to the application data request at step S228.

Meanwhile, UI template providing system 140 may send a UI template registration request to application data server 130 when creating an UI template according to a request of a user (see FIG. 5) or when receiving a pre-made UI template from a user For example, UI template providing system 140 may create a UI template when receiving template constituent information from a user (see FIG. 5) and send a registration request (i.e., a UI template registration request) including the created UI template to application data server 130 at step S210. When receiving the registration request, application data server 130 may determine whether the UI template is proper to a registration. That is, application data server 130 may determine whether the UI template satisfies a predetermined registration condition. Particularly, a registration condition may be differently predetermined according to types of M2M device 100. Application data server 130 may send either a registration refusal message or a registration approval message to UI template providing system 140 according to the determination results at step S212. When sending the registration approval message, application data server 130 may store a corresponding UI template in storage unit 131.

With respect to a relationship between M2M server 120 and application data server 130, when receiving the device data request from application data server 130 at step S224, M2M server may retrieve a device data (e.g., a sensing data) corresponding to the received device data request from storage unit 121 and then send the retrieved device data to application data server in response to the received device data request at step S226. In at least one embodiment of the present invention, when the device data request includes a control command, M2M server 120 may control a corresponding M2M device and receive device data (i.e., device data reflecting a control result) from the corresponding M2M device.

With respect to a relationship between M2M device 100 and M2M server 120, M2M device 100 may periodically or in real-time send device data (e.g., a sensing data) to M2M server 120 at step S200. In at least one embodiment of the present invention, M2M device 100 may send device data (e.g., sensing data) to M2M server 120 whenever a request is received from M2M server 120 or whenever a predetermined event (e.g., a preset temperature change, an extraordinary situation) happens. M2M server 120 may store the device data received from M2M device 100 in storage unit 121.

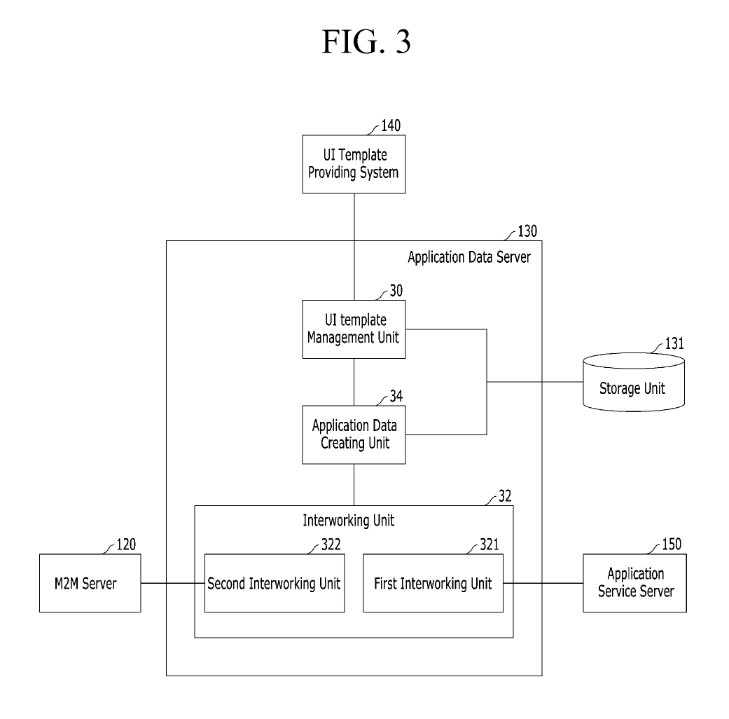

FIG. 3 illustrates an application data server in accordance with at least one embodiment of the present invention.

Referring to FIG. 3, application data server 130 may include UI template management unit 30, interworking unit 32, and application data creating unit 34 in accordance with at least one embodiment of the present invention. Particularly, application data server 130 may create application data using at least one hardware processor.

UI template management unit 30 may receive at least one UI template from UI template providing system 140. In at least one embodiment of the present invention, UI template management unit 30 may receive at least one UI template to be registered, from user terminal 160 or a template developer terminal. When receiving a registration request (i.e., a UI template registration request) including a UI template, UI template management unit 30 may determine whether the received UI template is proper to a corresponding M2M device. UI template management unit 30 may determine whether the received UI template satisfies a predetermined registration condition. The UI template may include at least one of device identification information, a device type, a device data type, a device data range, a device control type, and GUI format information. Constituent information and a registration procedure of the UI template will be described in more detail with reference to FIG. 4A and FIG. 4B. Furthermore, the UI template may be created based on characteristics (e.g., types) of M2M device 100. Therefore, UI templates may be different according to the type of M2M device 100.

When the UI template is improper, i.e., when the UI template does not satisfy a corresponding registration condition, UI template management unit 30 may send a registration refusal message to UI template providing system 140. When the UI template is proper, i.e., when the UI template satisfies the corresponding registration condition, UI template management unit 30 may send a registration approval message to UI template providing system 140. UI template management unit 30 may store a proper UI template (i.e., an approved UI template) in storage unit 131. UI template management unit 30 may store/manage the proper UI templates by M2M device types.

In at least one embodiment of the present invention, UI template management unit 30 may provide an editing function for registered UI templates to a template registrant such as UI template providing system 140, a user, a template developer, and/or an M2M service provider. The template registrant may edit or modify the registered UI template.

Interworking Unit 32 may communicate with M2M server 120 and/or application service server 150 and perform an interface procedure such that application data server 130 can interwork with M2M server 120 and/or application service server 150. More specifically, interworking unit 32 may include first interworking unit 321 and second interworking unit 322.

First interworking unit 321 may perform an interworking procedure with application service server 150. In the interworking procedure, first interworking unit 321 may receive an application data request from application service server 150. First interworking unit 321 may use application programming interface (API) in order to receive the application data request. When an application data is created by application data creating unit 34, first interworking unit 321 may send the created application data to application service server 150.

Meanwhile, second interworking unit 322 may perform an interworking procedure with M2M server 120. In the interworking procedure, second interworking unit 322 may send a device data request to M2M server 120 and receive corresponding device data from M2M server 120 in response to the sent device data request. More specifically, when first interworking unit 321 receives an application data request from application service server 150 and transfer the received application data request to application data creating unit 34, application data creating unit 34 may obtain device identification information on a corresponding M2M device by analyzing the transferred application data request. Thereafter, according to a request of application data creating unit 34, second interworking unit 322 may send a device data request to M2M server and receive corresponding device data from M2M server 120 in response to the device data request.

Application data creating unit 34 may analyze the application data request which first interworking unit 150 has received from application service server 150. Application data creating unit 34 may obtain (or identify) device identification information on a corresponding M2M device based on analysis results of the application data request. Herein, the device identification information may indicate M2M device 100 corresponding to an application service request of a user. Further, application data creating unit 34 may create a device data request to be sent to a corresponding M2M server. Herein, the corresponding M2M server is a server which stores a device data received from M2M device 100 corresponding to the obtained device identification information. The created device data request may be sent to the corresponding M2M server 120 by second interworking unit 322.

Second interworking unit 322 may receive device data from M2M server 120 and transfer it to application data creating unit 34. When device data is received from M2M server 120 in response to a device data request, application data creating unit 34 may create application data to be sent in response to the received application data request. More specifically, application data creating unit 34 may retrieve a UI template to be used for a corresponding M2M application service from storage unit 131 and create the application data by combining the retrieved UI template with the received device data. The created application data may be transferred to application service server 150 through first interworking unit 321. An application data creation procedure will be described in more detail with reference to FIG. 6A and FIG. 6B.

FIG. 4A and FIG. 4B illustrate registering a user interface (UI) template in accordance with at least one embodiment of the present invention. For example, application data server 130 may register at least one UI template according to a registration request (i.e., a UI template registration request) received from UI template providing system 140.

Referring to FIG. 4A, when receiving constituent information required for a UI template creation, UI template providing system 140 may create a UI template based the received constituent information at step S400. A UI template creation procedure will be described in more detail with reference to FIG. 5.

At step S402, UI template providing system 140 may send a UI template registration request including the created UI template, to application data server 130. In at least one embodiment of the present invention, UI template providing system 140 may receive a UI template (i.e., a pre-made UI template) created by a template creator such as an M2M service provider, a user, or a template developer. In this case, UI template providing system 140 may send the UI template registration request including the pre-made UI template without performing at step S402.

At step S404, when receiving the UI template registration request from UI template providing system 140, application data server 130 may analyze the UI template included in the received UI template registration request. Constituent information of a UI template will be described in more detail with reference to FIG. 5.

At step S406, application data server 130 may identify a registration condition (i.e., a UI template registration condition) corresponding to the received UI template. The registration condition may be predetermined by an M2M service provider, and be stored in application data server 130. The registration condition may be differently predetermined according to types of M2M device 100. Since the registration condition was already described with reference to FIG. 1 and FIG. 2, the detailed description thereof is omitted.

At step S408, application data server 130 may determine whether the received UI template satisfies the identified registration condition. In other words, such determination procedure may be a procedure determining whether the received UI template is suitable for representing information on a corresponding M2M device and accommodating a corresponding device data.

At step S410, when the received UI template does not satisfy the identified registration condition, i.e., when the received UI template is improper (No-5408), application data server 130 may send a registration refusal message to UI template providing system 140.

At step S412, when the received UI template satisfies the identified registration condition, i.e., when the received UI template is proper (Yes-S408), application data server 130 may send a registration approval message to UI template providing system 140.

At step S414, application data server 130 may store an approved UI template (i.e., a proper UI template satisfying a registration condition) in storage unit 131. For example, the proper UI template may be stored as shown in Table 1-1 trough Table 1-3 below.

TABLE 1-1

```
<template>
  <device id=“temperature”/>
  <header img=“temp.jpg”/>
  <text size=20 value=$current °C/>
  ...
  </template>
```

TABLE 1-2

<template>
<device id=“humidity”/>
<header img=“humi.jpg”/>
<text size=20 value=$current %/>
...
</template>

TABLE 1-3

<template>
<device id=“airquality”/>
<header img= “airq.jpg”/>
<text size=20 value=$current %/>
...
</template>

At step S416, application data server 130 may send the stored (i.e., registered) UI template to application service server 150. In at least one embodiment of the present invention, application data server 130 may send the stored UI template according to a request of application service server 150.

Hereinafter, a UI template registration procedure accompanying “a template ID allocation procedure” will be described with reference to FIG. 4B.

Referring to FIG. 4B, a UI creating operation (S420), a registration requesting operation (S422), a UI template analysis operation (S424), a registration condition identifying operation (S426), a determination operation (S428), and registration refusal/approval message sending operation (S430, S432) are basically the same as steps S400 to S412 described in FIG. 4A. Accordingly, the detailed description of such operation is omitted.

At step S434, application data server 130 may allocate template identifier (ID) to an approved UI template (i.e., a proper UI template satisfying the UI template registration condition).

At step S436, application data server 130 may store the approved UI template along with the allocated template ID in storage unit 131. For example, the approved UI template may be stored as shown in Table 1-1 trough Table 1-3 above.

At step S438, application data server 130 may send the stored (i.e., registered) UI template and the allocated template ID to application service server 150. In at least one embodiment of the present invention, application data server 130 may send the stored UI template and the allocated template ID according to a request of application service server 150. Application service server 150 may store/manage UI templates and corresponding template IDs received from application data server 130. Application service server 150 may provide the stored/managed UI templates and/or template IDs to user terminal 160 according to a user request. In at least one embodiment of the present invention, application data server 130 may register/manage UI templates which are received from user terminal 160 or a template developer terminal. For example, a user may directly send a UI registration request of UI templates to be used in association with his/her M2M application service to application data server 130, and modify the registered UI templates.

As described above, application data server 130 may register/manage a variety of UI templates to be used in an M2M application service without being dependent on an M2M service provider, an M2M device manufacturer. Furthermore, UI templates and device data are independently registered (or stored)/managed. Accordingly, even though a new M2M device or a new M2M application service appears, if a corresponding UI template is registered, a user may receive the new M2M application service without installing a new UI application in the user terminal.

FIG. 5 illustrates creating a user interface (UI) template in accordance with at least one embodiment of the present invention. That is, FIG. 5 illustrates the UI template creation procedure (S400). For example, UI template providing system 140 may create a UI template according to a request from a template creator (e.g., an M2m service provider, a user, or a third template developer). In this case, with respect to a UI template creation process, UI template providing system 140 may correspond to “a server” and the template creator (more specifically, a template creator terminal) may correspond to “a client.” The template creator may access UI template providing system 140 through a network such as core network 112, in order to create UI templates to be M2M application services.

Referring to FIG. 5, UI template providing system 140 may provide the template creator with at least one UI menu for selecting/inputting template constituent information at step S500.

At step S502, UI template providing system 140 may receive template constituent information from a template creator. For example, the template creator may input (or define) at least one template constituent information (e.g., device identification information, a device data type, a device data range, a device control type, and/or GUI format information) through various schemes (e.g., a menu selection, a direct input, etc.).

At step S504, UI template providing system 140 may create a UI template configured to include the received template constituent information, using a UI markup language such as Hyper Text Markup Language (HTML), or eXtensible Markup Language (XML). The created UI template may be sent to application data server 130 for UI registration according to a registration request of the template creator (S402, S422). Furthermore, after a UI registration procedure are performed as shown in FIG. 4A and FIG. 4B, the template creator may access application data server 130 and edit the registered UI template.

In at least one embodiment of the present invention, a UI template creation algorithm as shown in FIG. 5 may be installed in a terminal of a template creator such as a user, a third template developer, or an M2M service provider. In this case, user terminal 160, a template creator terminal, and/or a terminal (or a system) of the M2M service provider may correspond to UI template providing system 140. For example, the UI template creation algorithm is installed, a user may create at least one UI template to be used in his/her M2M application service.

Hereinafter, constitution information of a UI template will be described in more detail. The UI template may be configured to include (or accommodate) at least one of device identification information, a device type, a device data type, a device data range, a device control type, and GUI format information.

Device identification information may be information necessary to identify a specific M2M device and/or a corresponding M2M device type. The device identification information may be formed by a number, a character, a symbol, and/or a combination thereof. For example, in the case that an M2M device is a temperature control device, corresponding device identification information may be described as <device id=“temperature”>. In case of a humidity control device, corresponding device identification information may be described as <device id=“humidity”>. In case of an air conditioning device, a corresponding device identification information may be described as <device id=“airquality”>. Furthermore, device identification information may be used to retrieve a UI template corresponding to an M2M device associated with an application data request when application data server 130 receives an application data request from application service server 150.

The device type may indicate a type of an M2M device (e.g., a temperature control device, a humidity control device, etc.) associated with a corresponding UI template. For example, in case of a temperature control device, a corresponding device type may be expressed as <temperature>.

A device data type may indicate a type of data which are generated by M2M device 100. The device data type may be variously determined according to a type of an M2M device. For example, in case of a temperature control device, a corresponding data type may be expressed as <temperature 01>, <temperature 02>, and so forth. Herein, <temperature 01> and <temperature 02> may indicate “integer type” and “floating point type,” respectively. Furthermore, types of data created by M2M device 100 may further include sub-data types.

A device data range may indicate a range of data which are generated by M2M device 100. The device data range may be variously determined based on a type of M2M device and/or a corresponding data type (i.e., a type of the data created by a corresponding M2M device). For example, in case of a temperature control device, a device data range may be about −50˜100° C.

A device control type may be variously determined according to a type of an M2M device. For example, in case of a temperature control device, the device control type may be a control type of <cooling>, <heating>, and so forth. The device control type may include sub-control types. For example, in case of a temperature control device, a sub-device control type may be expressed as <cooling=3° C.>. Alternatively, in this case, a sub-device control types may be expressed as <current>, <maximum>, and/or <minimum>.

GUI format information may be information on a display format of data (e.g., an image, a type face, an icon, etc.) to be displayed on a display unit of user terminal 160. The GUI format information may be variously determined according to a type of an M2M device. For example, in case of a temperature control device, GUI format information may be <img=“temp.jpg”> and <text size=20>.

FIG. 6A and FIG. 6B illustrate providing a machine-to-machine (M2M) service in accordance with at least one embodiment of the present invention.

Referring to FIG. 6A, when receiving an application service request (e.g., a request for sensing a temperature of a specific location) from user terminal 160 at step S600, application service server 150 may obtain “device identification information” (i.e., device identification information of a corresponding M2M device) and/or “a requested service content” associated with the received application service request at step S602. More specifically, when user terminal 160 requests an M2M application service associated with at least one of M2M devices 100-1 through 100-N, application service server 150 may obtain a corresponding M2M device identification information and/or the requested service content by analyzing the received application service request.

At step S604, application service server 150 may create an application data request including the obtained device identification information and/or the requested service content and send the created application data request to application data server 130. Herein, device identification information included in the application service request and/or the application data request may be used to distinguish a corresponding M2M device from other M2M devices. Furthermore, a device type (e.g., a temperature control device, a humidity control device, etc.) may be identified from the device identification information.

At step S606, when receiving the application data request from application service server 150, application data server 130 may obtain device identification information and/or a requested service content by analyzing the received application data request. For example, application data server 130 may obtain information (e.g., device identification information, device type) on an M2M device (e.g., M2M device 100-1) associated with an application service. Furthermore, application data server 130 may obtain a requested service content associated with the corresponding M2M device (e.g., M2M device 100-1).

At step S608, application data server 130 may send a device data request to M2M server 120, based on the obtained device identification information and/or the requested service content.

At step S610, when receiving the device data request from application data server 130, M2M server 120 may retrieve device data (e.g., a temperature data, a humidity data, etc.) corresponding to the device data request from storage unit 121. In at least one embodiment of the present invention, storage unit 121 may be included in M2M server 120. In at least one embodiment of the present invention, a device data request may include a control command (e.g., a control command requesting a specific operation). In this case, M2M server 120 may control a corresponding M2M device and receive a device data (i.e., a device data reflecting a control result) from the corresponding M2M device.

At step S612, M2M server 120 may send the retrieved device data to application data server 130. For example, in the case that an M2M device is a temperature control device including a temperature sensor and an application service requested by a user is to provide current temperature information, M2M server 120 may retrieve a corresponding device data (e.g., a temperature data) associated with the requested application service and send the retrieved device data to application data server 130. Herein, the device data of this case may be described as shown in Table 2 below.

TABLE 2

```
<temperature>
      <current>
      24
      </current>
</temperature>
```

At step S614, application data server 130 may retrieve a UI template corresponding to the device identification information obtained at step S606, from storage unit 131. Application data server 130 may identify a device type of a corresponding M2M device from the device identification information and retrieve a UI template corresponding to the identified template type. For example, in the temperature control case described above, application data server 130 may retrieve a UI template including <device id=“temperature”> as device identification information, among UI templates stored in storage unit 131. The retrieved UI template may be described as shown in Table 3 below.

TABLE 3

```
<template>
  <device id=“temperature”/>
  <header img=“temp.jpg”/>
  <text size=20 value=$current °C/>
  ...
</template>
```

At step S616, application data server 130 may create an M2M application data by combining the received device data and the retrieved UI template. For example, in the temperature control case described above, the created M2M application data may be described as shown in Table 4 below.

TABLE 4

<device id=“temperature”>
<img src=“/temperature/tem.jpg”/>
<font size=10> 24°C</font>
...
</device>

At step S618, application data server 130 may send the created M2M application data to application service server 150. For example, application data server 130 may send the created M2M application data to application service server 150 through a local network such an intranet network.

At step S620, when receiving the M2M application data from application data server 130, application service server 150 may provide an application service using the received M2M application data. For example, application service server 150 may create application UI data by combining the received application data and an additional UI component. Unlike, in at least one embodiment of the present invention, when the application service request is related with an M2M device, application service server 150 may transfer an application data received from application data server 130 to user terminal 160, without an additional process for UI. In this case, user terminal 160 may display the transferred application data without using a specific UI application.

In at least one embodiment of the present invention, the application service request may be related with a plurality of M2M devices (e.g., a temperature control device, a humidity control device, an air conditioning device). In this case, application data server 130 may obtain a plurality of device data at step S612 and retrieve a plurality of UI templates at step S614. Application data server 130 may individually create a plurality of application data by combining each UI template and a corresponding device data at step S616. In this case, application data server 130 may send the plurality of application data to application service server 150 at step S618. In this case, application service server 150 may create an application UI data by combining the plurality of M2M application data as shown in Table 5 below, and then send the created application UI data to user terminal 160 in response to the application service request at step S620.

TABLE 5

```
<html>
  <div id=“temperature”> ... </div>
  <div id=“humidity”> ... </div>
  <div id=“airquality”> ... </div>
</html>
```

In at least one other embodiment of the present invention, application data server 130 may create one application data (i.e., an integral application data) by combining the plurality of application data at step S616, and then send the integral application data to application service server 150 at step S618. Herein, the integral application data may described as shown in Table 5 above.

Meanwhile, FIG. 6B illustrates providing an M2M service based on a template ID in accordance with at least one embodiment of the present invention.

Referring to FIG. 6B, when receiving an application service request (e.g., a request for sensing a temperature of a specific location) from user terminal 160 at step S640, application service server 150 may obtain “device identification information” (i.e., device identification information of a corresponding M2M device), “a requested service content,” and/or “a template ID” associated with the received application service request at step S642. More specifically, when user terminal 160 requests an M2M application service associated with at least one of M2M devices 100-1 through 100-N, application service server 150 may obtain a corresponding M2M device identification information, the requested service content, and/or the template ID by analyzing the received application service request.

At step S644, application service server 150 may create an application data request including the obtained information (e.g., device identification information, the requested service content, and/or the template ID) and send the created application data request to application data server 130. Herein, device identification information included in the application service request and/or the application data request may be used to distinguish a corresponding M2M device from other M2M devices. Furthermore, device type (e.g., a temperature control device, a humidity control device, etc.) may be identified from the device identification information.

At step S646, when receiving the application data request from application service server 150, application data server 130 may obtain device identification information a requested service content, and/or a template ID by analyzing the received application data request. For example, application data server 130 may obtain information (e.g., device identification information, device type) on an M2M device (e.g., M2M device 100-1) associated with an application service. Further, application data server 130 may obtain a requested service content associated with the corresponding M2M device (e.g., M2M device 100-1). Application data server 130 may obtain a template ID indicating a UI template to be used to create an application data. In at least one embodiment of the present invention, when an application service request (e.g., in case of requesting “temperature data” and “humidity data”) is associated with a plurality of M2M devices, the received application data request may include a plurality of template IDs.

At step S648, application data server 130 may send a device data request to M2M server 120, based on the obtained device identification information and/or the requested service content.

At step S650, when receiving the device data request from application data server 130, M2M server 120 may retrieve a device data (e.g., temperature data, humidity data, etc.) corresponding to the received device data request from storage unit 121. In at least one embodiment of the present invention, storage unit 121 may be included in M2M server 120. In at least one embodiment of the present invention, a device data request may include a control command (e.g., a control command requesting a specific operation). In this case, M2M server 120 may control a corresponding M2M device and receive a device data (i.e., a device data reflecting a control result) from the corresponding M2M device.

At step S652, M2M server 120 may send the retrieved device data to application data server 130. For example, in the case that an M2M device is a temperature control device including a temperature sensor and an application service requested by a user is to provide current temperature information, M2M server 120 may retrieve a corresponding device data (e.g., a temperature data) associated with the requested application service and then send the retrieved device data to application data server 130.

At step S654, application data server 130 may retrieve a UI template corresponding to the template ID obtained at step S646, from storage unit 131. In the case that the received application data request includes a plurality of template IDs, application data server 130 may retrieve a plurality of UI templates corresponding to the plurality of template IDs.

At step S656, application data server 130 may create an M2M application data by combining the received device data and the retrieved UI template.

At step S658, application data server 130 may send the created M2M application data to application service server 150. For example, application data server 130 may send the created M2M application data to application service server 150 through a local network such an intranet network.

At step S660, when receiving the M2M application data from application data server 130, application service server 150 may provide an application service using the received M2M application data.

In the case that the application service request is related with a plurality of M2M devices and a plurality of template IDs are obtained from the application data request, application data server 130 may create a plurality of application data at and create integral application data by combining the plurality of application data, at step S656. In at least one embodiment of the present invention, application data server 130 may send the plurality of application data to application service server 150. In this case, application service server 150 may create an application UI data by combining the plurality of M2M application data. Since an integral application data creation procedure and an application UI data creation procedure were already described with reference to FIG. 6A, the detailed description thereof is omitted.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of providing a machine-to-machine (M2M) service, the method comprising:
obtaining device identification information on a specific M2M device associated with a requested M2M service;
obtaining device data corresponding to the device identification information;
determining a user interface (UI) template corresponding to the requested M2M service; and
creating an M2M application data by combining the obtained device data and the determined UI template.

2. The method of claim 1, wherein the device identification information is obtained from an application data request received from an application service server.

3. The method of claim 1, wherein the obtaining device data includes:
sending a device data request based on the device identification information, to an M2M server; and
receiving the device data from the M2M server, in response to the device data request.

4. The method of claim 1, wherein the determining includes:
identifying a device type from the device identification information; and
retrieving the UI template corresponding to the identified device type, from a storage unit.

5. The method of claim 2, wherein the determining includes:
obtaining template identification information from an application data request; and
retrieving the UI template corresponding to the obtained template identification information, from a storage unit.

6. The method of claim 5, wherein the retrieving includes:
when the template identification information includes a plurality of template identifiers,
retrieving a plurality of UI templates corresponding to the plurality of template identifiers.

7. The method of claim 6, wherein the creating includes:
creating a plurality of M2M application data by combining each of the plurality of retrieved UI templates and a corresponding device data; and
creating an integral application data by combining the plurality of M2M application data.

8. The method of claim 1, further comprising:
receiving a registration request including at least one UI template, from at least one of a UI template providing system, a user terminal, and a template developer terminal;
determining whether each of the at least one template satisfies a predetermined registration condition; and
storing a UI template which satisfies the predetermined registration condition.

9. The method of claim 8, wherein each of the at least one UI template is configured to include at least one of device identification information, a device type, a device data type, a device data range, a device control type, and graphical user interface (GUI) format information.

10. The method of claim 9, wherein the predetermined registration condition is established in association with at least one of the device data type, the device data range, the device control type, and essential constituent information.

11. The method of claim 1, wherein the method is performed by an application data server coupled to at least one of an M2M server and an application service server through an intranet network.

12. The method of claim 11, further comprising:
sending the created M2M application data to the application service server for transfer of the created M2M application data to a user terminal.

13. A method of registering a user interface (UI) template for a machine-to-machine (M2M) service, the method comprising:
receiving a registration request including at least one UI template;
determining whether each of the at least one UI template satisfies a predetermined registration condition; and
storing a UI template which satisfies the predetermined registration condition.

14. The method of claim 13, wherein each of the at least UI template is configured to include at least one of device identification information, a device data type, a device data range, a device control type, and graphical user interface (GUI) format information.

15. The method of claim 14, wherein the predetermined registration condition is established in association with at least one of the device data type, the device data range, the device control type, and essential constituent information.

16. The method of claim 13, wherein:
the method is performed by an application data server coupled to at least one of an M2M server and an application service server through an intranet network; and
the registration request is received from at least one of a UI template providing system, a user terminal, and a template developer terminal.

17. An apparatus for providing a machine-to-machine (M2M) service, the apparatus comprising:
a template managing unit configured to store at least one user interface (UI) template;
an interworking unit configured to obtain a device data from an M2M server; and
an application data generating unit configured to determine a UI template to accommodate the obtained device data among the at least one stored UI template, and to create an M2M application data by combining the obtained device data and the determined UI template.

18. The apparatus of claim 17, wherein the interworking unit is configured to:
receive an application data request from an application service server;
send a device data request to the M2M server;
receive a corresponding device data from the M2M server; and
send the created M2M application data to the application service server.

19. The apparatus of claim 18, wherein the application data generating unit is configured to:
obtain at least one of device identification information, a requested service content, and a template identifier (ID) from the application data request;
determine the UI template based on at least one the obtained device identification information and the obtained template identifier (ID); and
create the M2M application data by combining the received corresponding device data and the determined UI template.

20. The apparatus of claim 18, wherein the apparatus is an application data server coupled to at least one of the M2M server and the application service server through an intranet network.
